(19) United States
(12) Patent Application Publication
(10) Pub. No.: US 2012/0247806 A1
(43) Pub. Date: Oct. 4, 2012

(54) CORONA DISCHARGE-RESISTANT INSULATING VARNISH COMPOSITION COMPRISING SURFACE-TREATED SILICA AND INSULATED WIRE HAVING INSULATED LAYER FORMED USING THE SAME

(75) Inventors: Hyung-Sam CHOI, Seoul (KR); Joon-Hee Lee, Gunpo-si (KR); Ki-Hong Park, Bucheon-si (KR); Sun-Joo Park, Gunpo-si (KR)

(73) Assignee: LS Cable & System Ltd., Anyang-si (KR)

(21) Appl. No.: 13/432,433

(22) Filed: Mar. 28, 2012

(30) Foreign Application Priority Data
Mar. 31, 2011 (KR) 10-2011-0029649

(51) Int. Cl. H01B 3/30; C08K 5/544; B82Y 30/00

(52) U.S. Cl. 174/110 N; 524/262; 977/773; 977/785

(57) ABSTRACT

Disclosed is an insulating varnish composition including polyamideimide resin and 1 to 40 parts by weight of surface-treated silica in a sol state per 100 parts by weight of the polyamideimide resin. An insulated layer formed using the insulating varnish composition may have excellent corona discharge resistance, thereby preventing the insulation breakdown.

### CROSS-REFERENCE TO RELATED APPLICATION(S)

This application claims priority from Korean Patent Application No. 10-2011-0029649, filed on Mar. 31, 2011, the entire disclosure of which is incorporated herein by reference for all purposes.

### BACKGROUND

1. Field

Exemplary embodiments relate to a corona discharge-resistant insulating varnish composition and an insulated wire having an insulated layer formed using the same.

2. Description of the Related Art

A corona discharge is an electrical discharge brought on by an electric field concentrated at a small crack created in an insulator of an insulated wire or an insulated cable. The corona discharge may deteriorate the insulation properties, which may lead to insulation degradation, and eventually insulation breakdown. In particular, in the case of a coil (or transformer) used in motors and the like, more specifically, an enameled wire having a coating formed by coating a conductor with an insulating varnish, followed by curing, a corona discharge may occur between or within the wires (coatings) and as the coating is decomposed due to the collision of charged particles, heat may be generated, resulting in insulation breakdown.

Recently, in systems having an inverter motor used for energy saving, there tends to be an increase in a corona discharge due to overcharge caused by surge of an inverter, resulting in insulation breakdown.

To suppress the corona discharge, suggestion has been made to provide an enameled wire having an insulator formed by dispersing inorganic insulating particles such as alumina, magnesia, silica, or titania in a resin solution. The inorganic insulating particles may prevent the occurrence of a corona discharge, and may improve the thermal conductivity, reduce the thermal expansion, and increase the strength of the enameled wire.

To disperse inorganic insulating particles in heat-resistant resin, a method for directly adding inorganic insulating particle powder to a resin solution is known in the art. However, this method has low solution stability because inorganic insulating particles sediment rather than dissolve in a resin solution. In the manufacturing of an insulated wire, when a conductor is coated with such a resin solution having low solution stability, the workability reduces.

To overcome this drawback, suggestions have been made to mix a sol having dispersed inorganic insulating particles with a resin solution. This has advantages in that it is easy to mix a sol having dispersed inorganic insulating particles with a resin solution and excellent dispersion, leading to an insulated wire having excellent appearance and flexibility, but the resin solution should have good miscibility with a solvent of the sol having dispersed inorganic insulating particles.

However, a majority of solvents used in an insulating varnish cannot favorably form a sol wherein inorganic insulating particles are uniformly dispersed in a solvent, and some solvents capable of dispersing inorganic insulating particles therein have low miscibility with a resin solution, resulting in coagulation in an insulating varnish. Also, the dispersion of inorganic insulating particles in an insulating varnish may be temporarily improved under limited conditions, however problems may occur to the insulating varnish in aspects of long-term storage, stability, reproducibility, and the like.

### SUMMARY OF THE INVENTION

The present invention is designed to solve the above problems, and therefore it is an object of the present invention to provide an insulating varnish composition having excellent miscibility between inorganic insulating particles and an insulating resin solution, and an insulated wire using the same.

According to an aspect of the present invention, provided is an insulating varnish composition including polyamideimide resin and surface-treated silica in a sol state. Preferably, the content of the surface-treated silica in a sol state may be 1 to 40 parts by weight per 100 parts by weight of the polyamideimide resin.

According to another aspect of the present invention, provided is an insulated wire having an insulated layer formed by coating a conductor with an insulating varnish composition, the insulating varnish composition including polyamideimide resin and 1 to 40 parts by weight of surface-treated silica in a sol state per 100 parts by weight of the polyamideimide resin.

The surface-treated silica may have an average particle diameter of 5 to 500 nm

The surface-treated silica may be obtained by surface-treating silica with at least one selected from the group consisting of amine, epoxy, thiol, carboxylic acid, sulfonic acid, phosphoric acid, phosphine, and cyanic acid. For example, the surface-treated silica in a sol state may include at least one selected from the group consisting of 3-aminopropyltrimethoxysilane, N-2-aminoethyl-3-aminopropyltrimethoxysilane, 3-glycidoxypropyltrimethoxysilane, 3-mercaptopropyltrimethoxysilane, 3-isocyanatopropyltrimethoxysilane, N-(beta-aminoethyl)gamma-aminopropyltrimethoxysilane, N-(beta-aminoethyl)gamma-aminopropylmethyldimethoxysilane, and gamma-ureidopropyltrimethoxysilane.

### ADVANTAGEOUS EFFECTS

The insulated layer formed using an insulating varnish composition having inorganic insulating particles of silica uniformly dispersed therein according to the present invention has excellent corona discharge resistance, thereby preventing the insulation breakdown.

### BRIEF DESCRIPTION OF THE DRAWINGS

FIG. 1 is a scanning electron microscope (SEM) image of an insulated layer formed from an insulating varnish composition obtained in Example 3.

FIG. 2 is an SEM image of an insulated layer formed from an insulating varnish composition obtained in Comparative Example 7.

### DESCRIPTION OF THE PREFERRED EMBODIMENT

Hereinafter, the present invention will be described in detail.

Silica has low affinity to polyamideimide resin since silica has a hydroxyl group—OH on the surface thereof. Accordingly, general silica or silica sol has low miscibility with polyamideimide resin.

When silica is surface-treated to have a functional group allowing chemical bonds, silica can form covalent or non-covalent bonds with polyamideimide resin to improve the miscibility with polyamideimide resin. The inventors completed the present invention based on the fact that when surface-treated silica in a sol state is mixed with a polyamideimide resin solution, the miscibility between the surface-treated silica and the resin solution improves.

The present invention provides an insulating varnish composition including polyamideimide resin and surface-treated silica in a sol state.

The surface-treated silica is obtained by surface-treating silica with at least one selected from the group consisting of amine, epoxy, thiol, carboxylic acid, sulfonic acid, phosphoric acid, phosphine, and cyanic acid. The surface-treated silica is used in a sol state to create a colloid in a solvent of water, alcohol, ketone, ester, hydrocarbon, and the like.

The surface-treated silica enabling the formation of a sol or colloid has an average particle diameter of 5 to 500 nm. When the average particle diameter is less than 5 nm, a functional group allowing chemical bonds cannot be favorably formed on the silica surface because the silica particles have high surface energy and cohesive strength. When the average particle diameter exceeds 500 nm, the insulated layer may deteriorate due to the collision between the silica particles and charged particles resulting from a corona discharge.

Specifically, the surface-treated silica in a sol state may be 3-aminopropyltrimethoxysilane, N2-aminoethyl-3-aminopropyltrimethoxysilane, 3-glycidoxypropyltrimethoxysilane, 3-mercaptopropyltrimethoxysilane, 3-isocyanatopropyltrimethoxysilane, N-(beta-aminoethyl)gamma-aminopropyltrimethoxysilane, N-(beta-aminoethyl)gamma-aminopropylmethyldimethoxysilane, and gamma-ureidopropyltrimethoxysilane, singularly or in combination.

Preferably, the content of the surface-treated silica in a sol state is 1 to 40 parts by weight per 100 parts by weight or the polyamideimide resin. When the content of the surface-treated silica in a sol state is less than 1 part by weight, the corona discharge-resistant effect is not sufficiently obtained, and when the content exceeds 40 parts by weight, the silica may agglomerate.

The above insulating varnish composition may be coated onto a conductor to form an insulated layer on the conductor. When an insulated wire is manufactured using a conductor with an insulated layer, the insulated wire has excellent appearance and flexibility.

### EXAMPLES

Hereinafter, various preferred examples of the present invention will be described in detail for better understanding. However, the examples of the present invention may be modified in various ways, and they should not be interpreted as limiting the scope of the invention. The examples of the present invention are provided so that persons having ordinary skill in the art can better understand the invention.

### Examples 1 to 4 and Comparative Examples 1 to 4

A solvent was prepared by mixing 50 ml of ammonia solution (30 wt %), 2,500 ml of ethanol, and 90 ml of distilled water. 150 ml of tetra alkoxy silane was added to the solvent, followed by stirring for 12 hours. For surface treatment, 50 ml of 3-aminopropyltrimethoxysilane was added thereto. Subsequently, stirring was performed for another 12 hours. A solid was separated by centrifugal separation and then dispersed in an alcohol-based solvent to produce a surface-treated silica sol.

Corona-discharge resistant insulating varnish compositions according to examples 1 to 4 and comparative examples 1 to 4 were prepared by mixing the surface-treated silica sol with polyamideimide resin (containing 25% non-volatiles) at mix ratios in Table 1 below.

### Comparative Examples 5 to 8

A solvent was prepared by mixing 50 ml of ammonia solution (30 wt %), 2,500 ml of ethanol, and 90 ml of distilled water, and 150 ml of tetra alkoxy silane was added to the solvent, followed by stirring for 12 hours. Subsequently, a solid was separated by centrifugal separation and then dispersed in an alcohol-based solvent to produce a silica sol.

Insulating varnish compositions according to comparative examples 5 to 8 were prepared by mixing the silica sol with polyamideimide resin (containing 25% non-volatiles) at mix ratios in Table 1 below.

The unit of the components indicated in Table 1 is parts by weight.

TABLE 1

| | | | Surface-treated | |
|---|---|---|---|---|
| | | Polyamideimide resin | silica sol | Silica sol |
| Example | 1 | 100 | 1 | — |
| | 2 | | 5 | — |
| | 3 | | 10 | — |
| | 4 | | 25 | — |
| Comparative | 1 | 100 | — | — |
| example | 2 | | 0.5 | — |
| | 3 | | 50 | — |
| | 4 | | 100 | — |
| | 5 | | — | 1 |
| | 6 | | — | 5 |
| | 7 | | — | 10 |
| | 8 | | — | 25 |

Determination and Evaluation of Properties

By using the insulating varnish compositions prepared according to examples 1 to 4 and comparative examples 1 to 8, a test was made to determine the dispersion and corona discharge resistance, and the test results are shown in Table 2. The test conditions are as follows:

(Evaluation of Dispersion)

To evaluate the dispersion of silica included in the insulating varnish composition, after a copper conductor of 0.9 mm diameter was coated with each of the insulating varnish compositions of examples and comparative examples at 30 micrometer thickness, a resulting insulated layer was peeled off and then its cross section was observed using a SEM to check whether the silica agglomeration occurred or not. Also, the particle diameter (nm) of a largest silica particle among the silica particles present within a predetermined coated area (200 μm² cross sectional area) was measured by a scale bar found at the bottom of a SEM image and a ruler, and then recorded. No agglomeration means excellent dispersion, and the smaller the silica particle, the higher the dispersion.

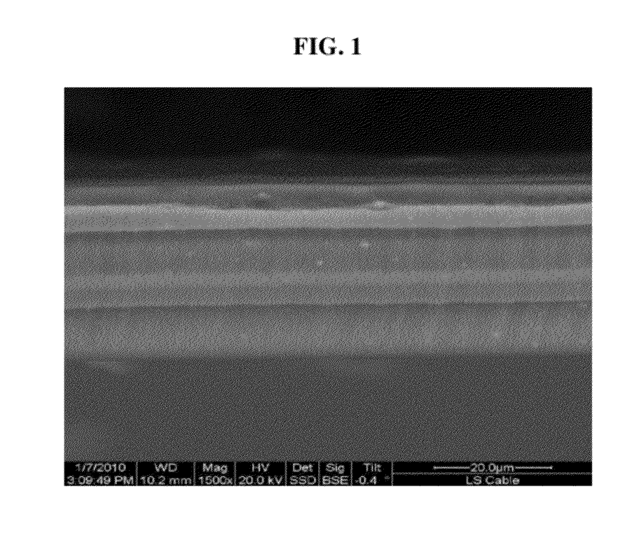

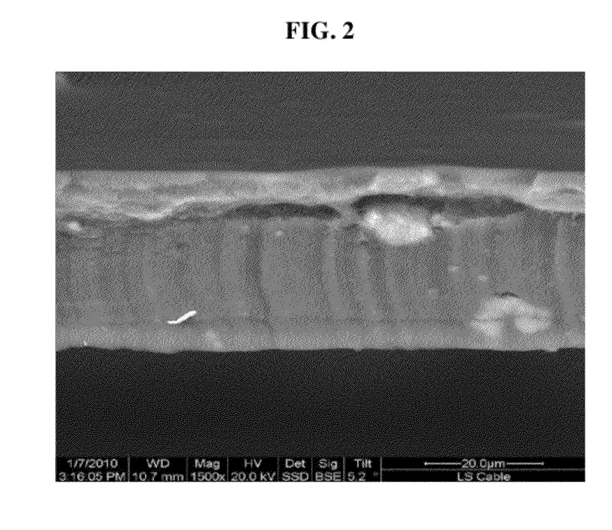

A SEM image of the insulated layer using the insulating varnish composition of example 3 is shown in FIG. 1. Also, a SEM image of the insulated layer using the insulating varnish composition of comparative example 7 is shown in FIG. 2.

(Evaluation of Corona Discharge Resistance)

To evaluate the corona discharge resistance of the insulating varnish composition, after a copper conductor of 0.9 mm diameter was coated with each of the insulating varnish compositions of examples and comparative examples, a sine wave current of 2,000 Vp (zero to peak voltage) and 10 kHz was applied at room temperature. The pulse endurance time was measured and recorded. No cracking means excellent corona discharge resistance, and the longer the pulse endurance time, the higher the corona discharge resistance.

TABLE 2

| | | | | Corona |
|---|---|---|---|---|
| | | | Dispersion | discharge |
| | | Transparency | (Silica particles (nm)) | resistance |
| Example | 1 | Transparent | Good (70-80) | 1 h 23 m |
| | 2 | Transparent | Good (70-80) | 2 h 30 m |
| | 3 | Transparent | Good (70-80) | 5 h 55 m |
| | 4 | Opaque | Good (110-120) | 10 h 22 m |
| Comparative | 1 | Transparent | — | 30 m |
| example | 2 | Transparent | Good (70-80) | 35 m |
| | 3 | Opaque | Agglomerate (13500) | Cracking |
| | 4 | Opaque | Agglomerate (15200) | Cracking |
| | 5 | Opaque | Agglomerate (5500) | 32 m |
| | 6 | Opaque | Agglomerate (7800) | 38 m |
| | 7 | Opaque | Agglomerate (10400) | 25 m |
| | 8 | Opaque | Agglomerate (21100) | 29 m |

As seen in Table 2, examples 1 to 4 have excellent dispersion and corona discharge resistance because they use a surface-treated silica sol, for example, 3-aminopropyltrimethoxysilane.

In contrast, comparative example 1 exhibits poor corona discharge resistance because it does not use inorganic insulating particles.

Comparative example 2 exhibits poor corona discharge resistance because it uses a surface-treated silica sol but does not meet the minimum content (less than 1 part by weight) of the surface-treated silica sol required by the present invention.

Comparative examples 3 and 4 exhibit poor dispersion and corona discharge resistance because they use a surface-treated silica sol but do not meet the maximum content of the surface-treated silica sol required by the present invention.

Comparative example 5 to 8 exhibit poor dispersion and corona discharge resistance because they use silica without surface treatment.

Also, referring to the SEM images of FIGS. 1 and 2, the insulating varnish composition according to example 3 of the present invention does not have agglomerated silica, but the insulating varnish composition of comparative example 7 shows a considerable extent of the silica agglomeration.

Although the present invention has been described hereinabove, it should be understood that the detailed description and specific examples, while indicating preferred embodiments of the invention, are given by way of illustration only, since various changes and modifications within the spirit and scope of the invention will become apparent to those skilled in the art from this detailed description.

What is claimed is:

1. An insulating varnish composition, comprising:
polyamideimide resin; and
surface-treated silica in a sol state.

2. The insulating varnish composition according to claim 1,
wherein the content of the surface-treated silica in a sol state is 1 to 40 parts by weight per 100 parts by weight of the polyamideimide resin.

3. The insulating varnish composition according to claim 2,
wherein the surface-treated silica is obtained by surface-treating silica with at least one selected from the group consisting of amine, epoxy, thiol, carboxylic acid, sulfonic acid, phosphoric acid, phosphine, and cyanic acid.

4. The insulating varnish composition according to claim 3,
wherein the surface-treated silica in a sol state includes at least one selected from the group consisting of 3-aminopropyltrimethoxysilane, N2-aminoethyl-3-aminopropyltrimethoxysilane, 3-glycidoxypropyltrimethoxysilane, 3-mercaptopropyltrimethoxysilane, 3-isocyanatopropyltrimethoxysilane, N-(beta-aminoethyl)gamma-aminopropyltrimethoxysilane, N-(beta-aminoethyl)gamma-aminopropylmethyldimethoxysilane, and gamma-ureidopropyltrimethoxysilane.

5. The insulating varnish composition according to claim 2,
wherein the surface-treated silica has an average particle diameter of 5 to 500 nm.

6. An insulated wire comprising:
a conductor; and
an insulated layer formed by coating the conductor with an insulating varnish composition,
the insulating varnish composition including:
polyamideimide resin; and
1 to 40 parts by weight of surface-treated silica in a sol state per 100 parts by weight of the polyamideimide resin.

7. The insulated wire according to claim 6,
wherein the surface-treated silica is obtained by surface-treating silica with at least one selected from the group consisting of amine, epoxy, thiol, carboxylic acid, sulfonic acid, phosphoric acid, phosphine, and cyanic acid.

8. The insulated wire according to claim 7,
wherein the surface-treated silica in a sol state includes at least one selected from the group consisting of 3-aminopropyltrimethoxysilane, N2-aminoethyl-3-aminopropyltrimethoxysilane, 3-glycidoxypropyltrimethoxysilane, 3-mercaptopropyltrimethoxysilane, 3-isocyanatopropyltrimethoxysilane, N-(beta-aminoethyl)gamma-aminopropyltrimethoxysilane, N-(beta-aminoethyl)gamma-aminopropylmethyldimethoxysilane, and gamma-ureidopropyltrimethoxysilane.

9. The insulated wire according to claim 8,
wherein the surface-treated silica has an average particle diameter of 5 to 500 nm.
